(19) United States
(12) Patent Application Publication
(10) Pub. No.: US 2019/0317968 A1
(43) Pub. Date: Oct. 17, 2019

(54) METHOD, SYSTEM AND COMPUTER PROGRAM PRODUCTS FOR RECOGNISING, VALIDATING AND CORRELATING ENTITIES IN A COMMUNICATIONS DARKNET

(71) Applicant: TELEFONICA DIGITAL ESPAÑA, S.L.U., Madrid (ES)

(72) Inventors: Sergio DE LOS SANTOS VILCHEZ, Madrid (ES); Carmen TORRANO GIMÉNEZ, Madrid (ES); Aruna Prem BIANZINO, Madrid (ES)

(73) Assignee: TELEFONICA DIGITAL ESPAÑA, S.L.U., Madrid (ES)

(21) Appl. No.: 16/469,864

(22) PCT Filed: Dec. 16, 2016
(86) PCT No.: PCT/ES2016/070903

§ 371 Date: Jun. 14, 2019

(51) Int. Cl. G06F 16/951; G06F 16/958; H04L 29/06

(52) U.S. Cl. CPC G06F 16/951; H04L 63/1433; G06F 16/958

(57) ABSTRACT

The method according to the invention comprises the steps of: identifying one or more entities (21) located in a darknet (50) taking into consideration information relative to network domains thereof, and collecting information of said one or more entities (21) identified; extracting a series of metadata from the information collected from said one or more entities (21) identified; validating said one or more identified entities (21) with information from a surface network (51), said information coming from a surface network (51) associated with the information collected from the identified entities (21); and generating a profile of each identified entity (21) by correlating the validated information of each entity (21) with data and metadata from said surface network (51).

### TECHNICAL FIELD

The present invention generally relates to the field of communication network security. In particular, the invention relates to a method, system and computer program products for recognising, validating and correlating entities in a darknet, which can be correlated with illegal or suspicious activities.

The following definitions shall be taken into account herein:
Surface network: any web service or web page which can be indexed by a standard search engine (for example, Google or Yahoo!)
Deep web: any web service or web page which is not indexed by search engines (for example, content the access to which involves a prior use of a search box. The search engine crawling does not interact with search boxes)
Darknet: a small portion of the deep web that has been intentionally hidden and is inaccessible through conventional web browsers (including anonymous networks).
Crawling: systematic browsing of a network, typically using a bot/controller, for the purpose of indexing the network and searching for information.
Entity: an object (service, application or user) which has been identified in the network and for which an entry is created in the database. Said entry is referred to in the database as “profile”.
Metadata: literally, data about data. For example, a script file can include metadata about the time and time zone in which it has been compiled, or the character set used, whereas a web page can include metadata about the author, the last edit date, possible keywords, etc.

### BACKGROUND OF THE INVENTION

The purpose of darknets (Tor for example) is to hide the identity of a user and the activity of the network from any network surveillance and traffic analysis. Networks of this type take advantage of what is referred to as the “onion routing”, which is implemented by means of encryption in the application layer of the communication protocol stack, nested like the layers of an onion.

Darknets encrypt data, including the destination IP address, multiple times, and send it through a virtual circuit comprising randomly selected successive forwarding nodes within the darknet. Each repeater decrypts an encryption layer only to reveal the next repeater in the circuit to which it is to pass the remaining encrypted data. The final repeater decrypts the innermost layer of the encryption and sends the original data to its destination without revealing or even knowing the source IP address (therefore, the original data of the data is decrypted only during the last hop). Due to the fact that the communication routing is partially hidden in each hop in the darknet circuit, this method eliminates any unique point in which the communication pairs can be determined through network surveillance which is based on knowing the source and destination.

Some known solutions include:

Ahmia: This is a search engine for hidden contents in the Tor network. The engine uses a full-text search using crawled data from websites. OnionDir is a list of known online hidden service addresses. A separate script compiles this list and fetches information fields from the HTML (title, keywords, description, etc.). Furthermore, users can freely edit these fields. Ahmia compiles three types of popularity data: (i) Tor2web nodes share their visiting statistics with Ahmia, (ii) public WWW backlinks to hidden services, and (iii) number of clicks in the search results. Unlike the present invention, Ahmia does not extract metadata, it only extracts data for search engines in .onion domains and does not analyse user entities.

PunkSPIDER: This is a crawler that uses a customised script indexing .Onion sites in an Solr database. From there, sites are browsed to find vulnerabilities in the application layer. The process is distributed using a Hadoop cluster. Unlike the present invention, PunkSPIDER does not analyse metadata and does not allow searching for possible violations of IPR, reputation and marks.

TorScouter: This is a hidden service search engine which crawls the Tor network. Every time the crawler finds a new hidden service, it accesses, reads, and indexes it. Each unique link on the page is analysed and if a new hidden service is found, the engine then proceeds to the discovery process. The system analyses and stores the following information: (i) page title, (ii) .onion address and route, (iii) represented text from HTML, (iv) keywords for a full-text index, (v) no attachments/images/or other downloaded and/or indexed information are downloaded. Every time a new and unknown hidden service is found, the discovery process memorizes the address, tries to contact it and record the address, title, textual contents, and last display date. If the hidden service is responding to a request of the crawler, it is executed in the service. A secondary process indexes in a full-text index the textual contents of each page and prepares the actual content search. TorScouter is limited to only a text, title, and URL search, and it does not include any analysis of the available metadata. In these solutions, keywords within the text are searched for in order to index the entities identified in the search engine, whereas in the present invention a set of keywords of known alerts is searched for in the text for generating alerts possible.

EgotisticalGiraffe: This NSA's solution allows identifying Tor users (i) by detecting HTTP requests from the Tor network to particular servers, (ii) by redirecting the requests from those users to special servers, (iii) by infecting the terminal of those users to prepare a future attack on that terminal, filtering information to NSA servers. EgotisticalGiraffe attacks the Firefox browser and not the Tor tool itself. This is a “man-on-the-side” attack and it is hard for any organisation other than the NSA to execute it in a reliable manner because it requires the attacker to have a privileged position on the internet backbone and exploits a “race condition” between the NSA server and the legitimate website. Nonetheless, the de-anonymisation of users remains possible only in a limited number of cases and only as a result of a manual effort. This solution does not search for metadata to be correlated to the entity either, but rather it instead monitors activity on the darknet. Additionally, the solution requires a complex and powerful infrastructure. In fact, once a request for access has been detected at the network border, the source is redirected to a fake copy of the target server (which should have a shorter response time than the original target service), and the fake server will inject malicious software into the source device which maintains the monitoring of the entity.

Likewise, some patent applications are known. For example, patent application US-A1-20120271809 describes different techniques for monitoring cyber activities from different web portals and for collecting and analysing information for generating a malicious or suspicious entity profile and generating possible events. Despite the fact that this solution includes a crawler for compiling information about the analysed entities, this solution, unlike the present invention, refers to non-anonymous parts of the Internet. Likewise, the solution described in this US patent application does not include metadata extracted from the data analysed through the identification of fields specific.

Patent application CN 105391585 describes a solution which crawls darknets in the network layer, searching for network topology. This solution acts in the network layer and not in the application layer, discovering nodes and not services and entities. As such, the entities are not associated with any piece of metadata.

Patent application US20150215325 describes a system for collecting data from information requests which seems suspicious and may represent potential attacks on the actual data and infrastructure. The solution collects information including the source IP address of the request, the required data and metadata, the number and order of necessary resources, the search terms used, etc. The solution described in this US patent application refers only to network security, providing tools and methodologies for improving network security. Finally, the collected information is obtained in a passive manner, by collecting data petitions and not actively crawling the network.

New methods and/or systems for recognising, validating and correlating entities in a darknet, such that the mentioned correlation of the entities identified, which today is essentially performed manually, can be automated are therefore needed.

### DISCLOSURE OF THE INVENTION

To that end, according to a first aspect some embodiments of the present invention provide a method for recognising, validating and correlating entities such as services, applications, and/or users in a darknet such as Tor, Zeronet, i2p, Freenet, or others, wherein in the proposed method a computing system comprises: identifying one or more of the mentioned entities located on the darknet taking into consideration information relative to network domains of the darknet, and collecting information of said one or more entities identified; extracting a series of metadata from the information collected from said one or more entities identified; validating, where possible, said one or more identified entities with information from a surface network, said information coming from the surface network associated with the information collected from each of the identified entities; and automatically generating a profile of the identified entities by correlating the validated information of each entity with data and metadata from said surface network.

Therefore, the computing system has three objectives: to recognise entities, validate them (provide certainty to their level of validity), and correlate the information for performing attribution.

The purpose of the obtained result is to facilitate and provide support to the investigative work that is usually performed today by expert operators manually (i.e., not automatically), and the purpose is for generating profiles of the identified entities.

In one embodiment, the mentioned correlation is performed furthermore taking into consideration validated information of the other entities identified. Therefore, the profile generation process allows correlating entities to organisations, to other activities, to services, and users. Furthermore, at least some of the entities identified with a series of users, services, and/or places identified in the surface network can also be mapped.

The information collected from said one or more entities identified, prior to said validating, is stored in a memory or database of the computing system. Likewise, the mentioned information from the surface network including data and metadata is also stored in the memory or database.

In one embodiment, it is further checked whether the information collected from a given entity and the series of metadata extracted and associated with said given entity coincide with a list of keywords generated from data acquired from public lists and/or from reports generated by operators specialising in interventions and/or security analysts, an alert being generated if the result of said check indicates that the check has been positive.

The information collected from said one or more entities identified can include a plain text file containing the description of the contents of a web page on the darknet (for example a HTML file), a plain text file containing scripts executed on the darknet (for example a Javascript file), a plain text file containing the description of the graphic design of a web page on the darknet (for example CSS), headers, documents, and/or files made or exchanged on the darknet and/or through a real-time text-based communication protocol used on the darknet (for example the IRC protocol).

The information from the surface network, where possible, can include a network domain registered with the same name as a network domain of the darknet, a user name registered in another network domain, or an e-mail address registered in another network domain.

In one embodiment, the information collected from said one or more entities identified comprises documents and/or files made or exchanged on the darknet including multimedia content. In this case, the method filters said multimedia content according to compliance and privacy policies and preventively deactivates the multimedia content if said compliance and privacy policies are met.

In another embodiment, the information collected from said one or more entities includes user name and password fields indicative of the presence of information with restricted access, which method comprises creating an account in said one or more entities, associating a password with said created account, validating the created user, and executing access to the information with restricted access.

In one embodiment, the generated profile or profiles can be shown through a display unit of the computing system for later use by operators specialising in interventions in communication networks and/or communication network security analysts. Likewise, the generated profile or profiles can be sent to a remote computing device, for example a PC, a mobile telephone, a tablet, among others, for later use through a user interface by said operators specialising in interventions in communication networks and/or communication network security analysts for later analysis of said one or more identified entities, for example.

According to a second aspect, some embodiments of the present invention provide a system for recognising, validating and correlating entities such as services, applications, and/or users of a darknet. The system comprises:
a darknet adapted for allowing an anonymous communication of said one or more entities through it;
a surface network; and
a computing system operatively connected with a said darknet and with said surface network and including one or more processing units adapted and configured for:
   identifying said one or more entities located on the darknet taking into consideration information relative to network domains of the darknet and collecting information of said one or more entities identified;
   extracting a series of metadata from the information collected from said one or more entities identified;
   validating, if possible, said one or more entities identified with information from the surface network, wherein said information from the surface network is associated with the information collected from the identified entities; and
   automatically generating a profile of each identified entity by correlating the validated information of each entity with data and metadata from said surface network.

The system also preferably includes a memory or database for storing the information collected from said one or more identified entities and the information from the surface network including the data and metadata.

Other embodiments of the invention disclosed herein also include computer program products for performing the steps and operations of the method proposed in the first aspect of the invention. More particularly, a computer program product is an embodiment having a computer-readable medium including encoded computer program instructions therein which, when executed in at least one processor of a computer system, cause the processor to perform the operations indicated herein as embodiments of the invention.

Therefore, the present invention, by means of the mentioned computing system, which is operatively connected with the communications darknet and surface network, can access available data not only before logging in but also after logging out, unlike other solutions. This functionality enriches the crawling range, being able to have access to areas restricted, which normally include more substantial information.

Likewise, the computing system can compile and manage a larger amount of metadata than any other known solution, including different types of metadata.

### BRIEF DESCRIPTION OF THE DRAWINGS

The preceding and other features and advantages will be better understood from the following merely illustrative and non-limiting detailed description of the embodiments in reference to the attached drawings, in which:

FIG. 1 schematically illustrates the elements that are part of the proposed system for recognising, validating and correlating entities in a darknet, according to a preferred embodiment.

FIGS. 2 and 3 schematically illustrate different types of information that can be compiled/collected from the different entities of the surface network. FIG. 2 refers to examples of information compiled when the entity corresponds to a service, whereas FIG. 3 refers to examples of information compiled when the entity corresponds to a user.

FIG. 4 schematically illustrates an embodiment of the correlation performed between different entities of the darknet.

FIG. 5 is a flow chart illustrating a method for recognising, validating and correlating entities in a darknet according to an embodiment of the present invention.

### DETAILED DESCRIPTION OF EMBODIMENTS

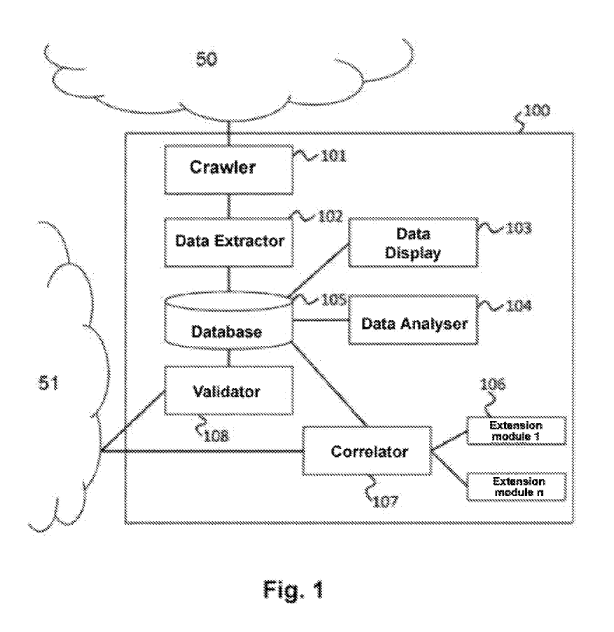

In reference to FIG. 1, a preferred embodiment of the proposed system is shown. According to the example of FIG. 1, a computing system 100 which includes one or more units/modules 101, 102, 103, 104, 105, 106, 107, 108 is operatively connected with a darknet 50 and a surface network 51 for recognising, validating and correlating entities 21 of the mentioned darknet. According to the present invention, the entities can comprise services, applications, and/or users. Likewise, the darknet 50 can be a Tor network, Zeronet, i2p, Freenet, etc.

Next each of the different units of the computing system 100 according to this preferred embodiment will be described in detail:
Crawling unit 101: This unit uses as input a set of domains (.onion for example) and manages the automatic crawling process. The unit includes a cache memory for storing the domains to be browsed and the domains which have already been browsed until the next update thereof.
Data extraction unit 102: This unit extracts data and information. It integrates an extension module system which allows including new possible types of metadata to be extracted. It includes a crawler for knowing which information is new and which information has already been processed. The data extraction unit 102 includes a list of keyword alerts (i.e., a list generated from public lists and the intervention of qualified experts, including terms correlated with child pornography, drugs, and other criminal activities). This list is compared with the data and metadata associated with the entities 21. If the result of said comparison is positive, an alert is established for the corresponding entity and the entity is left in standby for the analysis, pending the manual validation of a qualified expert, to avoid possible legal implications or to eliminate false positives.
Display unit 103: this is a display and search interface for the datasets indicating time stored in the database 105.
Data analyser 104: this includes a pattern integration module (which can be implemented using an AMQ module), an entity indexing module (which can be implemented using an SOLR module), a tracking module recording which information has already been processed and which information is new. This module can be connected to external information sources, including filters and blacklisted sensitive keywords.
Database 105: this database stores the information of the entity and all the associated information and metadata.
Extension module system 106: this is a modular system of extension modules, each of which is in charge of the extraction of a specific type of metadata of the surface network 51 (including data and metadata). The modular set can be extended where necessary, including new types of metadata.
Correlation unit 107: this unit is in charge of correlating the entities 21 defined with data and metadata, both compiled from the darknet 50 and from the surface network 51. This unit is in charge of the correlation between the entities 21 and the corresponding metadata (this functionality can be implemented using an AnalyslQ module, for example) and between different entities 21 (for example, one entity linked with the other, same set of keywords, etc.). This unit 107 can be connected with external information sources, including public or filtered databases.
Validation unit 108: this module is in charge of the validation of the identified entities 21 through data compiled from the surface network 51. This unit can be connected with external information sources, including public or filtered databases. Once an entity 21 is validated, a corresponding “validated” indication is established in the database 105.

For the recognition, validation and correlation, the computing system 100 is connected with the darknet 50 and executes a crawl to identify the entities 21. For example, for the particular case of a Tor darknet, the computing system 100 starts from a preliminary set of domains, .onion for example (initial crawl queue), including the domains on public lists, and collects related information to associate it as entities 21. This functionality is implemented in the crawling unit 101.

The information collected from the entity/entities 21 identified can include a plain text file containing the description of the contents of a web page on the darknet (for example an HTML file), a plain text file containing scripts executed on the darknet (for example a Javascript file), a plain text file containing the description of the graphic design of a web page on the darknet (for example CSS), headers, documents, and/or files exchanged on the darknet and/or through a real-time text-based communication protocol used on the darknet (for example the IRC protocol).

The entity/entities 21 identified is/are validated, where possible, with information obtained from the surface network 51, for example, a domain registered with the same name (in the event that it exists), a user name or an e-mail registered in other domains, etc. This functionality is implemented in the validation unit 108.

With the information compiled/collected, the computing system 100 extracts metadata including, for example, URL, domain, content type, headers, titles, text, tags, language, time indication, subtitles, etc. This functionality is implemented in the data extraction unit 102. If other .onion domains are linked there, they are added to the crawl queue of the crawling unit 101, for example in a recursive manner, and the resulting entity/entities 21 will be correlated in the database 105.

The contained extracted from each domain can include multimedia content (video and images), which may involve piracy and content with legal implications (child pornography for example). As such, this functionality can preventively be deactivated, depending on the laws in force. To that end, in one embodiment the computing system 100 filters the multimedia content according to compliance and privacy policies and preventively deactivates the multimedia content if these compliance and privacy policies are met.

In the case of web pages, the computing system 100 can detect if the analysed page is a login page, such as a forum or a social media site. The detection is based on the identification of login fields on the page (i.e., login fields and password). If a login page is detected, a suitable login management method, including the creation of an account, validation thereof, and access is automatically executed. This method allows the computing system 100 to also access information which is available only after the access, for example, for a content, which is currently not accessible for other solutions which do not access the deepest level of information on the web which requires logging in. This functionality is implemented by means of the data extractor module 102.

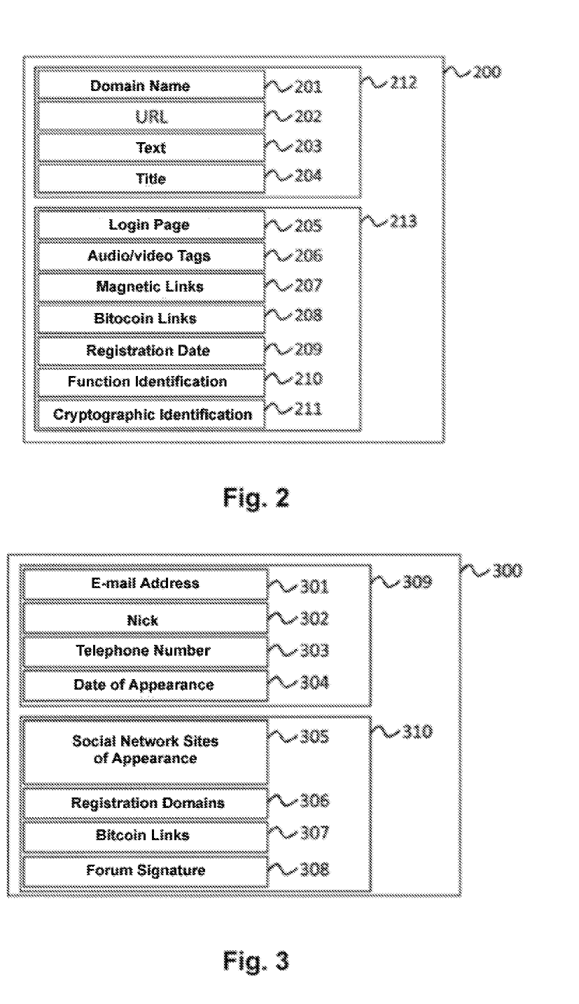

As indicated above, the entities 21 can comprise services, applications, and/or users. In one embodiment, the information which identifies an entity 21 as a service-type entity 200 (see FIG. 2) comprises: domain name, URL, text, title, etc. The entities 21 are associated with metadata such as a character set, a login page (yes/no), outbound and inbound links possible (i.e., links to other pages and links from other pages to the current domain), audio/video tags, magnetic links, bitcoin links, tile types, alerts, social media sites where it can be found, registration domains, a signature, etc.

The text and metadata included can be compared with a list of keywords generated from data acquired from public lists and/or from reports generated by operators specialising in interventions and/or security analysts, including terms correlated with child pornography, drugs, and other criminal activities, an alert being generated if the result of the check indicates that the check has been positive. If the alert is generated, the corresponding entity is left in standby for analysis, pending the manual validation of a qualified expert, to avoid possible legal implications or to eliminate false positives. This functionality is implemented by means of the data extractor 102.

Some metadata can be available only for entities relative to users 300, whereas other metadata can be only available for entities relative to services 200. FIG. 3 shows some examples of information which identifies an entity 21 as a user-type entity 300. Between the different data and metadata available for each entity 21, a subset of the information represents the identification information (212 for service entities and 309 for user entities), whereas the rest of the information represents additional information (213 for service entities and 310 for user entities).

On the basis of the stored metadata, similarities between entities 21 can be identified (a conventional feature of search engines which share, for example, the tags and keywords of different entities 21), and trends can be compiled for analysis (for example, specific or tags keywords which rise/fall in popularity, statistics about the population of the service, the technologies used, etc.). This functionality is implemented by means of the data analyser module 104.

Some of the tools used by the computing system 100 for extracting metadata and associating it with entities 21 can include:
Analysis and classification of generic metadata associated with code or binary files of a web page, as well as circumstantial data of the web page itself, for example, creation date.
Analysis and identification of web page JavaScript/CSS content, i.e., identification of patterns in the use of functions, which can represent a singularity for correlation, i.e., a pattern with a low occurrence, which can therefore be of help in the identification of an entity 21.
Analysis and identification of headers, including cryptographic headers (for example, hpkp).
Analysis and identification of the cryptographic information associated with the web page (for example, ciphering and/or certificate).
Analysis and identification of binary files (for example, jar, apks, exe, flash, etc.), including metadata about the compilers used, the time zone of the compilation, etc.
Analysis and identification of the cryptography associated with binary files (for example, apk signature).
Analysis and identification of the timeline associated with binary files (i.e., dates and date sequencing).
Extraction of information associated with e-mail addresses and nicks (i.e., tools for the automatic search for the existence of an e-mail address in other e-mail domains, or tools for the automatic search for the registration of the same nick/ID for social media sites).
Extraction of information associated with the registration of a domain (for example, registration date, registration e-mail address, associated IP address, etc.) through automatic tools (for example, domain tools).
The analysis and processing of natural language in forum publications for correlation (signatures for example).

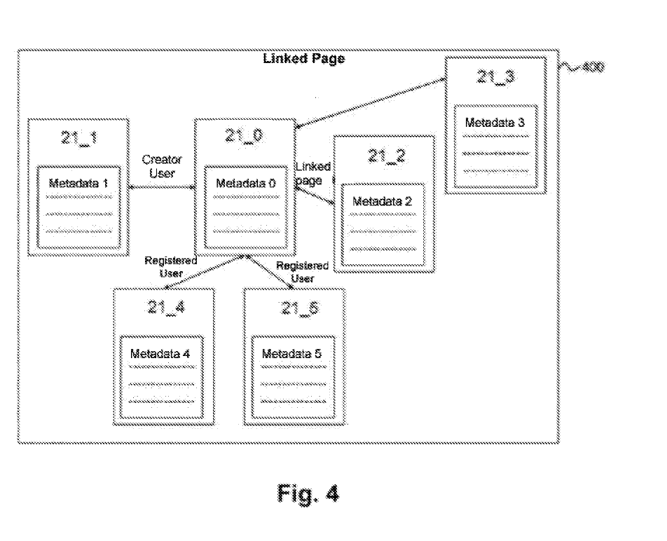

In reference to FIG. 4, it shows the correlation which is performed between the identified entities 21. In this example, entity 21_0 represents a service, entity 21_1 represents the user registered in the service, entity 21_2 and entity 21_3 represent other services linked to entity 21_0 and/or containing links to entity 21_0, whereas entity 21_4 and entity 21_5 represent users registered in a restricted area of entity 21_0.

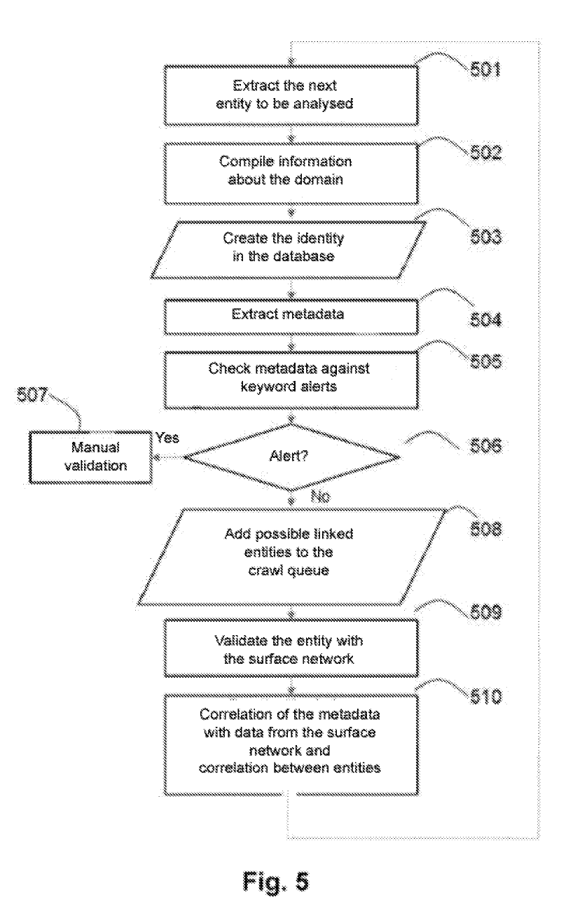

In reference to FIG. 5, it shows an embodiment of a method for recognising, validating and correlating entities in a darknet. According to this embodiment, the method extracts information from an entity 21 to be analysed (step 501) of the darknet, compiling information relative to the network domain (step 502). Once the previous steps are performed, the identity of the identified entity 21 is created in the database 105 (step 503), and metadata is extracted (step 504) from the information collected from the identified entity 21. Then, in step 505, it is checked if the extracted metadata coincides with a list of keywords, an alert being generated (step 506) in the event that the result of the check has been positive. In the event of the mentioned alert being generated (step 507), the entity in question is left in standby for analysis, pending the manual validation of a qualified expert, to avoid possible legal implications or to eliminate false positives. Otherwise (step 508), possible linked entity/entities from the entity 21 is/are added to the crawl queue 101. Finally, the entity 21 is validated (step 509) with information from the surface network 51 and the metadata of the entity 21 is correlated (step 510) with the data and metadata of the surface network 51, for generating a profile of the entity 21.

The proposed invention can be implemented in hardware, software, firmware, or any combination thereof. If it is implemented in software, the functions can be stored in or encoded as one or more instructions or code in a computer-readable medium.

The computer-readable medium includes computer storage medium. The storage medium can be any medium available which can be accessed by a computer. By way of non-limiting example, such computer-readable medium can comprise RAM, ROM, EEPROM, CD-ROM, or other optical disc storage, magnetic disc storage, or other magnetic storage devices, or any other medium which can be used for carrying or storing desired program code in the form of instructions or data structures and which can be accessed by a computer. Disk and disc, as used herein, include compact discs (CD), laser disc, optical disc, digital versatile disc (DVD), floppy disk and Blu-ray disk, where disks normally reproduce data magnetically, whereas discs reproduce data optically with lasers. Combinations of the foregoing must also be included within the scope of computer-readable medium. Any processor and the storage medium can reside in an ASIC. The ASIC can reside in a user terminal. As an alternative, the processor and storage medium can reside as discrete components in a user terminal.

As used herein, the computer program products comprising computer-readable media include all the forms of computer-readable media except to the point where that medium considers that they are not non-established transitory propagating signals.

The scope of the present invention is defined in the attached claims.

1. A method for recognising, validating and correlating entities in a communications darknet, the method being characterised in that it comprises:
a computing system identifying one or more entities located in a darknet taking into consideration information relative to network domains of the darknet, and collecting information of said one or more entities identified;
said computing system extracting a series of metadata from the information collected from said one or more entities identified;
said computing system validating said one or more identified entities with information from a surface network, said information coming from a surface network associated with the information collected from the identified entities; and
said computing system automatically generating a profile of each identified entity by correlating the validated information of each entity with data and metadata from said surface network.

2. The method according to claim 1, wherein said information collected from said one or more identified entities, prior to said validating, is stored in a memory or database of the computing system, and wherein said information from the surface network including data and metadata is also stored in the memory or database.

3. The method according to claim 1, which method further comprises:
checking if the information collected from a given entity and the series of metadata extracted from said given entity coincide with a list of keywords generated from data acquired from public lists and/or from reports generated by said operators specialising in interventions and/or security analysts; and
said computing system generating an alert if a result of said check indicates that the check has been positive.

4. The method according to claim 1, wherein said correlation is performed furthermore taking into consideration validated information of the other identified entities.

5. The method according to claim 1, which method further comprises mapping at least some of the identified entities with a series of users, services, and/or places identified in the surface network.

6. The method according to claim 1, wherein the information collected from said one or more identified entities includes at least one plain text file containing the description of the contents of a web page on the darknet, a plain text file containing scripts executed on the darknet, a plain text file containing the description of the graphic design of a web page on the darknet, headers, documents and/or files made or exchanged on the darknet and/or through a real-time text-based communication protocol used on the darknet.

7. The method according to claim 1, wherein the information from the surface network includes at least one network domain registered with the same name as a network domain of the darknet, a user name registered in another network domain, or an e-mail address registered in another network domain.

8. The method according to claim 1, wherein the information collected from said one or more identified entities comprises documents and/or files made or exchanged on the darknet including multimedia content, which method comprises filtering said multimedia content according to compliance and privacy policies and preventively deactivates the multimedia content if said compliance and privacy policies are met.

9. The method according to claim 1, wherein the information collected from said one or more entities includes user name and password fields indicative of the presence of information with restricted access, which method comprises creating an account in said one or more entities, associating a password with said created account, validating the created user, and executing access to the information with restricted access.

10. The method according to claim 1, which method further comprises showing said generated profile or profiles through a display unit for later use by operators specialising in interventions in communication networks and/or communication network security analysts.

11. The method according to claim 1, which method further comprises sending said generated profile or profiles to a remote computing device for later use through a user interface by operators specialising in interventions in communication networks and/or communication network security analysts for later analysis of said one or more identified entities.

12. The method according to claim 1, wherein said one or more entities comprise services, applications, and/or users located in said darknet.

13. A system for recognising, validating and correlating entities of a darknet, which system comprises:
a darknet adapted for allowing an anonymous communication of one or more entities (21) through it;
a surface network; and
a computing system operatively connected with said darknet and with said surface network and including one or more processing units adapted and configured for:
identifying said one or more entities located on the darknet taking into consideration information relative to network domains of the darknet and collecting information of said one or more entities identified;
extracting a series of metadata from the information collected from said one or more entities identified;
validating said one or more identified entities with information from the surface network, wherein said information from the surface network is associated with the information collected from the identified entities; and
automatically generating a profile of each identified entity by at least correlating the validated information of each entity with data and metadata from said surface network.

14. The system according to claim 13, which method further comprises a memory or database for at least storing said information collected from said one or more identified entities and said information from the surface network including the data and metadata.

15. The system according to claim 13, wherein said one or more entities comprise services, applications, and/or users located in said darknet.

16. A computer program product including computer-readable code instructions which, when executed in at least one processor of a computing system, implement a method according to claim 1.
